(19) United States
(12) Patent Application Publication
(10) Pub. No.: US 2015/0053612 A1
(43) Pub. Date: Feb. 26, 2015

(54) METHOD AND SYSTEM FOR TREATING WASTE MATERIAL

(71) Applicant: BIOLOGICAL PETROLEUM CLEANING LTD., Herzliya (IL)

(72) Inventors: Gilli Bitan-Banin, Tel Aviv (IL); David Amir, Herzliya (IL); Yael Barash, Yavne (IL); Idit Berlatzky, Jerusalem (IL)

(73) Assignee: BIOLOGICAL PETROLEUM CLEANING LTD., Herzliya (IL)

(21) Appl. No.: 14/376,441

(22) PCT Filed: Apr. 7, 2013
(86) PCT No.: PCT/IB2013/052769

§ 371 Date: Aug. 4, 2014

(51) Int. Cl. C02F 3/00

(52) U.S. Cl. CPC C02F 3/006; C02F 2209/02; C02F 2209/20; C02F 2203/00; C02F 2209/40; C02F 2209/08; C02F 2209/001
USPC 210/613; 210/85; 210/614

(57) ABSTRACT

A method of maintaining a bioreactor of a waste material treatment system is disclosed. The method comprises monitoring the condition of bacteria and/or waste material. If the condition satisfies a first set of criteria, bacteria is transferred from a bacterial backup container to the bioreactor. If the condition satisfies a second set of criteria, bacteria is transferred from the bioreactor to the bacterial backup container. In some embodiments of the present invention the method predicts the condition of the bacteria and/or waste material.

### CROSS-REFERENCE TO RELATED PATENT APPLICATIONS

This patent application claims priority from and is related to U.S. Provisional Patent Application Ser. No. 61/639,108, filed 27 Apr. 2012, this U.S. Provisional Patent Application incorporated by reference in its entirety herein.

### TECHNOLOGY FIELD

The present invention, in some embodiments thereof, relates to waste material treatment and, more particularly, but not exclusively, to treatment of waste material using bacteria.

### BACKGROUND OF THE INVENTION

A large amount of interest in treatment of municipal and industrial wastewaters has arisen as a result of environmental pollution concerns. Often in treatment of wastewater from industrial and municipal sources, the activated sludge process is employed for treatment and purification.

The biological treatment process takes advantage of the ability of bacteria to use wastewater constituents to provide the energy for microbial metabolism and the building blocks for cell synthesis. The metabolic activity removes contaminants from the wastewater. The process generally consists of maintaining an aeration basin in which wastewater is fed to a suspension of bacteria to form a mixed liquor. The mixed liquor is aerated to furnish oxygen for the respiration of the biomass which sorbs, assimilates and metabolizes the biological oxygen demand of the wastewater. After a suitable period of aeration, the mixed liquor is introduced to a clarifier in which the biomass settles and the treated wastewater overflows into a receiving stream. A portion of the settled biomass, which is concentrated at the bottom of the clarifier, is recycled to the aeration basin, and a portion is purged in order to maintain a constant biosolids inventory within the system.

Variations in flow rates, concentrations or other conditions give rise to fluctuations in influent wastewater quality. In particular, certain industrial events can result in the discharge of an organic or non-organic shock pollutant load into the wastewater collection system. Such shock loading can upset the balance of the microbial culture in the process with a resulting loss of wastewater treatment effectiveness. Following an upset, a new culture is introduced into the system to restart the bacteria growth needed for replacing the bacteria lost in the upset. Since the bacteria in the activated sludge have a relatively slow growth rate, a prolonged period of several weeks or even months is required to bring the system back to steady-state operations.

Numerous techniques have been proposed for improving the activated sludge process.

U.S. Pat. No. 6,555,002 discloses a technique which uses cone bottom shaped vessels for a sequential batch reaction that allows micro colonies to grow following conditions that upset the process, so as to grow microorganisms which recover from the upset conditions.

Additional background art includes U.S. Pat. Nos. 5,646,863, 5,779,911, 6,023,223, 6,596,171 and 6,625,569; and Leu et al., 2009, “Modeling the Performance of Hazardous Wastes Removal in Bioaugmentated Activated Sludge Processes,” Water Environment Research, 81, 11, 2309-2319.

### SUMMARY OF THE INVENTION

According to an aspect of some embodiments of the present invention there is provided a method of maintaining a bioreactor of a waste material treatment system. The bioreactor having therein bacteria for treating the waste material. The method comprises: monitoring the condition of the bacteria in the bioreactor; if the condition satisfies a first set of criteria, then transferring bacteria from a bacterial backup container having bacteria therein to the bioreactor; and if the condition satisfies a second set of criteria, then transferring bacteria from the bioreactor to the bacterial backup container.

According to some embodiments of the invention the method further comprises monitoring the condition of the waste material, wherein the first and the second set of criteria are applied to the waste material condition.

According to some embodiments of the invention the method further comprises, following the transfer of the bacteria from the bacterial backup container to the bioreactor, enhancing generation of biomass in the bioreactor.

According to some embodiments of the invention the method further comprises monitoring the condition of the bacteria in the bacterial backup container.

According to some embodiments of the invention the monitoring and the bacteria transfer is performed automatically.

According to some embodiments of the invention, if the condition satisfies the first set of criteria, then the bioreactor is drained prior to the transfer of bacteria from the bacterial backup container to the bioreactor.

According to some embodiments of the invention the bioreactor is fed continuously from the bacterial backup container when the condition of the bacteria in the bacterial backup container satisfies a predetermined set of criteria.

According to some embodiments of the invention the method further comprises, responsively to the condition, selecting a bacterial backup container from a plurality of bacterial backup containers, each having a different type of bacteria therein.

According to some embodiments of the invention the bioreactor comprises a waste material inlet for receiving a flow waste material from a main channel being connected to the waste material inlet, and wherein the method comprises: monitoring the condition of the waste material in the main channel at a monitoring location upstream of the waste material inlet, to provide test data pertaining to the condition; analyzing the monitoring data; and responsively to the analysis, diverting at least a portion of the flow to a secondary channel.

According to some embodiments of the invention the method comprises generating a flow of waste material into the bioreactor, and into a predictor bioreactor, wherein a relative influent flow rate is larger for the predictor bioreactor than for the bioreactor; monitoring the condition of bacteria or waste material in the predictor bioreactor; and responsively to the condition, issuing a report regarding the expected condition of bacteria in the bioreactor.

According to an aspect of some embodiments of the present invention there is provided a waste material treatment system. The system comprises: a bioreactor and a bacterial backup container each having therein bacteria for treating the waste material; a monitoring unit for monitoring the condition of the bacteria in the bioreactor; or waste material and a controller configured for receiving from the monitoring unit test data pertaining to the condition, and transferring bacteria between the bioreactor and the bacterial backup container responsively to the data; wherein if the condition satisfies a first set of criteria, then bacteria is transferred from the bacterial backup container to the bioreactor, and if the condition satisfies a second set of criteria, then bacteria is transferred from the bioreactor to the bacterial backup container.

According to some embodiments of the invention the monitoring unit is configured for monitoring the condition of the waste material, wherein the first and the second set of criteria are applied to the waste material condition.

According to some embodiments of the invention the monitoring unit is configured for monitoring the condition of the bacteria in the bacterial backup container.

According to some embodiments of the invention the monitoring unit is configured for monitoring the condition of the waste material and wherein the controller is configured for receiving from the monitoring unit test data pertaining to the condition and diverting at least a portion of the flow to a secondary channel responsively to the data.

According to some embodiments of the invention the system comprises a predictor bioreactor having therein bacteria; and at least one channel for carrying a flow of waste material into the bioreactor and into the predictor bioreactor; wherein a relative influent flow rate is larger for the predictor bioreactor than for the bioreactor; and wherein the monitoring unit is configured for monitoring the condition of bacteria or waste material in the predictor bioreactor, and wherein the controller is configured for receiving from the monitoring unit test data pertaining to the condition, and issuing a report regarding the expected condition of bacteria or waste material in the bioreactor, responsively to the test data.

According to some embodiments of the invention the system comprises a plurality of bacterial backup containers, each having a different type of bacteria therein, wherein the controller is configured to select a bacterial backup container from the plurality of bacterial backup containers responsively to the condition.

According to some embodiments of the invention the system comprises the controller is configured for allowing the bioreactor to continuously receive bacteria from the bacterial backup container when the condition of the bacteria satisfies a predetermined set of criteria.

According to some embodiments of the invention the system comprises the bacteria in the bacterial backup container is maintained at a sufficiently high viability state at all times.

According to some embodiments of the invention the system comprises the second set of criteria corresponds to an upset of the bacteria in the bioreactor.

According to an aspect of some embodiments of the present invention there is provided a method of predicting condition of waste material in waste material treatment system. The method comprises: generating a flow of waste material into a bioreactor and into a predictor bioreactor, wherein a relative influent flow rate is larger for the predictor bioreactor than for the bioreactor; monitoring the condition of bacteria or waste material in the predictor bioreactor; and responsively to the condition, issuing a report regarding the expected condition of waste material and bacterial activity

According to some embodiments of the invention the method further comprises monitoring the condition of the waste material, wherein the report is issued based on the waste material condition.

According to some embodiments of the invention the method further comprises issuing an alert if the condition indicates upset in the bacteria.

According to some embodiments of the invention the predictor bioreactor is kept at a temperature which is different than a temperature of the bioreactor. Typically, the temperature is selected to allow adequate, preferably optimal, biological activity. In some embodiments, the temperature is higher in the predictor bioreactor than in the bioreactor.

According to an aspect of some embodiments of the present invention there is provided a waste material treatment system. The system comprises: a bioreactor and a predictor bioreactor each having therein bacteria; at least one channel for carrying a flow of waste material into the bioreactor and into the predictor bioreactor, wherein a relative influent flow rate is larger for the predictor bioreactor than for the bioreactor; a monitoring unit for monitoring the condition of bacteria in the predictor bioreactor; and a controller configured for receiving from the monitoring unit test data pertaining to the condition, and issuing a report regarding the expected condition of the waste material, responsively to the test data.

According to some embodiments of the invention the monitoring unit is configured for monitoring the condition of the waste material, wherein the report is issued based on the waste material condition.

According to some embodiments of the invention the waste material condition is monitored at the predictor bioreactor.

According to some embodiments of the invention the waste material condition is monitored at the bioreactor.

According to some embodiments of the invention the waste material condition is monitored upstream the bioreactor.

According to some embodiments of the invention the waste material condition is monitored downstream the bioreactor.

According to an aspect of some embodiments of the present invention there is provided a method of treating waste material in a waste material treatment system. The system has a main channel being connected through a waste material inlet to a bioreactor. The method comprises: generating a flow of waste material in the main channel; monitoring the condition of the waste material in the main channel at a monitoring location upstream of the waste material inlet, to provide test data pertaining to the condition; analyzing the test data; and responsively to the analysis, diverting at least a portion of the flow to a secondary channel.

According to some embodiments of the invention the monitoring comprises measuring a plurality of parameters and using the parameters for calculating a score.

According to an aspect of some embodiments of the present invention there is provided a waste material treatment system. The system comprises: a bioreactor having therein bacteria, and being connected through a waste material inlet to a main channel carrying a flow of waste material into the bioreactor; a monitoring unit for monitoring the condition of the waste material in the main channel at a monitoring location upstream of the waste material inlet; and a controller configured for receiving from the monitoring unit test data pertaining to the condition, analyzing the test data, and diverting at least a portion of the flow to a secondary channel responsively to the analysis.

According to some embodiments of the invention the condition is characterized by at least one parameter selected from the group consisting of Dissolved oxygen (DO), Oxygen uptake rate (OUR), pH, Temperature, Total petroleum hydrocarbons (TPH), Chemical oxygen demand (COD), Biochemical oxygen demand (BOD), Total organic carbon (TOC), Non-purgable organic carbon (NPOC), Total suspended solids (TSS), Turbidity, bacterial concentration as obtained by any method, Conductivity, Chloride, Salinity, Total Nitrogen, Ammonia, Ammonium, Nitrite, Nitrate, N₂, Total phosphate, PO₄ (Orthophosphate), Oxidised & Ortho Phosphorus (OOP), Poly-Phosphates, Sulfide, Sulfate, Phenol, Poly aromatic hydrocarbons (PAH), Cresol, Detergents, Volatile suspended solids (VSS), CO₂, Cyanide, Total carbon (TC), Total inorganic carbon (TIC), Oil and grease, Optical absorbance, and Gas chromatography mass spectrometry parameters.

According to some embodiments of the invention the monitoring unit is configured for measuring a plurality of parameters and using the parameters for calculating a score.

According to some embodiments of the invention the waste material treatment system is an activated sludge treatment system.

According to some embodiments of the invention the waste material treatment system is an automated chemostat treatment system.

According to some embodiments of the invention the waste material treatment system is a sequential batch reactor treatment system.

According to some embodiments of the invention the waste material treatment system is a membrane bioreactor treatment system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram illustrating a method suitable for maintaining a bioreactor of a waste material treatment system according to various exemplary embodiments of the present invention;

FIG. 2 is a flowchart diagram illustrating a method suitable for predicting the condition of bacteria in a bioreactor of a waste material treatment system, according to various exemplary embodiments of the present invention;

FIG. 3 is a flowchart diagram illustrating a method suitable for treating waste material in a waste material treatment system, according to various exemplary embodiments of the present invention;

FIG. 4 is a schematic illustration of a waste material treatment system, which comprises a bacterial backup container having therein a bacterial population, according to various exemplary embodiments of the present invention;

FIG. 5 is a schematic illustration of a waste material treatment system, which comprises a predictor bioreactor, according to various exemplary embodiments of the present invention;

FIG. 6 is a schematic illustration of a waste material treatment system, which is configured to monitor waste material condition upstream an influent channel, according to various exemplary embodiments of the present invention;

FIGS. 7A and 7B are schematic illustrations of a combined waste material treatment system, according to various exemplary embodiments of the present invention; and

FIG. 8 is a schematic TOC level graph which can be used for predicting the condition of waste material or bacteria in a bioreactor waste material system, according to various exemplary embodiments of the present invention.

### DESCRIPTION OF SPECIFIC EMBODIMENTS OF THE INVENTION

The present invention, in some embodiments thereof, relates to waste material treatment and, more particularly, but not exclusively, to treatment of waste material using bacteria.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

It is to be further understood that, unless otherwise defined, the operations described hereinbelow can be executed either contemporaneously or sequentially in many combinations or orders of execution. Specifically, the ordering of the flowchart diagrams provided herein is not to be considered as limiting. For example, two or more operations, appearing in the following description or in a particular flowchart diagram in a particular order, can be executed in a different order (e.g., a reverse order) or substantially contemporaneously. Additionally, several operations described below are optional and may not be executed.

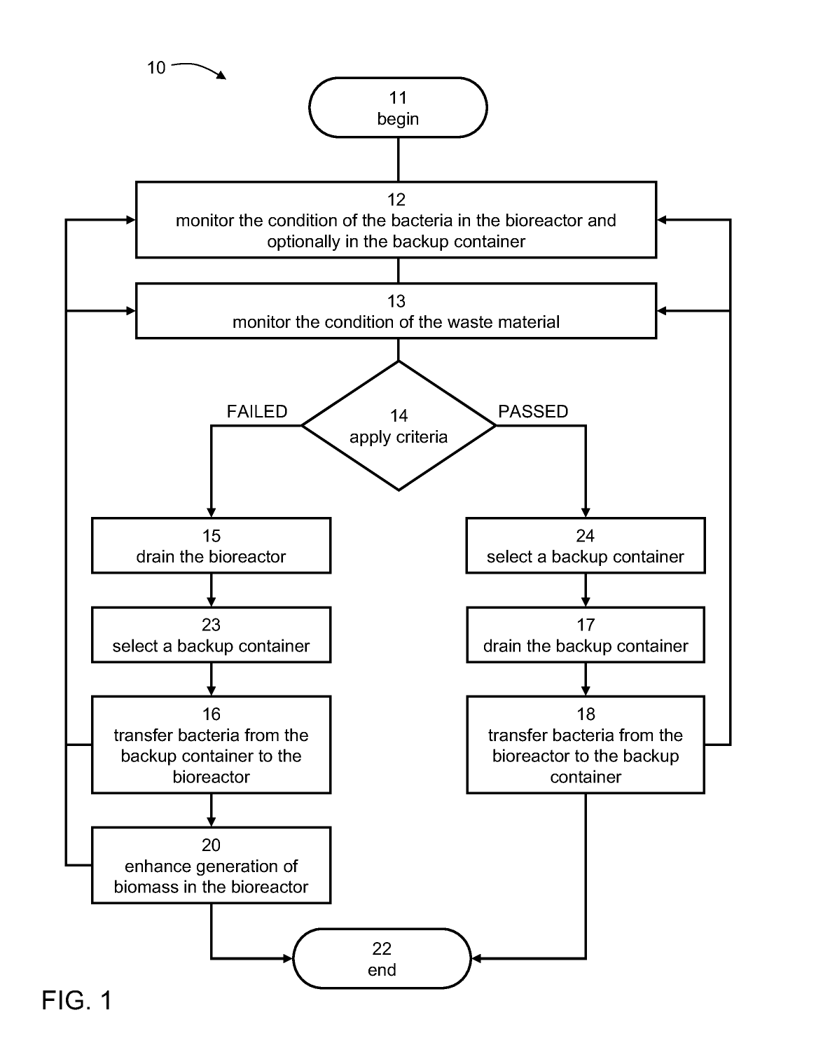

Referring now to the drawings, FIG. 1 is a flowchart diagram illustrating a method 10 suitable for maintaining a bioreactor of a waste material treatment system according to various exemplary embodiments of the present invention. The waste material treatment system can be of any type, provided at least part of the treatment is in a bioreactor via a biological process featured by organisms, microorganisms, bacteria and the like. For example, the system can be an automated chemostat system, an activated sludge system, a membrane bioreactor system, a sequential batch reactor (SBR) or the like. A description of representative waste material treatment systems suitable for the present embodiments is provided hereinunder. Additional examples of suitable systems are found in U.S. Published Application No. 20080308493, European Patent Application No. 08252000.8, and U.S. Pat. No. 6,845,336, the contents of which are hereby incorporated by reference. In various exemplary embodiments of the invention method 10 is executed using a system that includes one or more bacterial backup containers, as further detailed hereinunder.

The method begins at 11 and continues to 12 at which the condition of the bacteria and/or biological treatment process in the bioreactor is monitored. Optionally and preferably, the condition(s) of the bacteria in one or more bacterial backup containers is/are also monitored. At 13 the method can optionally and preferably also monitor the condition of the waste material at one or more monitoring locations, one of which is preferably upstream the bioreactor. Any of the monitoring operations 12 and 13 can independently be done continuously or intermittently, as desired. The condition can be monitored using one or more sensors or analyzers or any other measuring device arranged to measure one or more parameters. If desired, the sensors can provide continuous data such as provided by a continuously operating electronic instrument. The condition of the bacteria or waste material can be characterized by the measured parameter(s).

In some embodiments, the condition of the bacteria or waste material is characterized by the measured parameter(s) without further analysis. In some embodiments of the present invention the method analyzes the measured parameter(s) to determine the condition of the bacteria. For example, the method can calculate a statistical distribution for each of the measured parameters to provide a set of statistical distributions characterizing the condition of the bacteria. Also contemplated, are embodiments in which the conditions are characterized by a score calculated using the measured parameters. The score can be calculated using a predetermined relation between the score and each of various measured parameters. The score can also be calculated statistically, for example, by calculating statistical distribution for the respective parameters and combining the statistical distributions to provide the score. A combination of multiple parameters allows predicting cause and affect relationships. For example, carbon degradation is coupled to oxygen utilization. Oxygen uptake rate (OUR) may be decreased due to a temperature decrease, lower level of organic contamination in the influent, toxic/un-degraded compound in the influent, high flow which lead to bacterial wash (from the reactor) and more. If OUR decreases due to lower organic load, higher flow is preferred. If, on the other hand, the lower OUR is due to bacterial wash, slower flow is preferred since faster flow will aggravate the problem. By measuring multiple parameters, include, without limitation, OUR, Temperature, Flow and Total Organic Carbon in the influent, the cause of OUR decrease can be determined.

In some embodiments of the present invention the relation between the score and the measured parameters is updated adaptively, preferably using history data from previous measurements or data obtained from other sites in the same facility or other facilities. For example, an artificial neural network algorithm can be employed for calculating the score for any set of parameters based on the measured value of the parameters and on history data. A more detailed description of an artificial neural network algorithm suitable for the present embodiments is provided hereinunder.

Representative examples of parameters suitable for characterizing the condition of the bacteria in the bioreactor include, without limitation, Dissolved oxygen (DO), Oxygen uptake rate (OUR), pH, Temperature, Total petroleum hydrocarbons (TPH), Chemical oxygen demand (COD), Biochemical oxygen demand (BOD), Total organic carbon (TOC), Non-purgable organic carbon (NPOC), Total carbon (TC), Total inorganic carbon (TIC), Oil and grease, Total suspended solids (TSS), Turbidity, bacterial concentration as obtained by any method, Conductivity, Chloride, Salinity, Total Nitrogen, Ammonia, Ammonium, Nitrite, Nitrate, N₂, Total phosphate, PO₄ (Orthophosphate), Oxidised & Ortho Phosphorus (OOP), Poly-Phosphates, Sulfide, Sulfate, Phenol, Poly aromatic hydrocarbons (PAH), Cresol, Detergents, Volatile suspended solids (VSS), CO₂, Cyanide, Optical absorbance (visible, ultraviolet and/or infrared, e.g., via Fourier Transform Infrared Spectroscopy), and various parameters that can be obtained via techniques such as Gas chromatography mass spectrometry (GC-MS) which can be executed above the liquid surface in the bioreactor (e.g., CO₂, benzene, toluene, N₂). All these parameters are well-known to those skilled in the art of waste material treatment. Some of these parameters can be measured offline. These include, without limitation, cresol, cyanide and detergents, sulfate, sulfide, bacterial concentration as obtained by any method and VSS. Other parameters can be measured either online or offline, as desired.

Optionally the monitoring also includes receiving data from sources other than hard process or environmental instrumentation. Such data include laboratory test results, or data arriving from real-time databases of information collected at the facility at which the system is deployed. Also contemplated, are data obtained by simulations, particularly, but not necessarily, simulations of abnormal conditions, such as an upset condition which is further described hereinbelow. The simulation data can be obtained during laboratory simulations, field simulations and/or pilot-scaled simulations, as desired. Additionally, the method can receive discrete or non numeric data such as an indication that a sludge pump is operating or sludge level is rising. In some embodiments, the method receives data other than an instrument reading or test result, such as an operator voice record or a plant camera video input.

All received data can be complied and cross-linked so as to increase the accuracy, specificity and significance of the monitoring.

The method proceeds to decision 14 at which the method applies sets of criteria. The criteria are preferably applied automatically, but in some embodiment can be applied by the operator. If the condition satisfies a first criterion or a first set of criteria (a situation referred to as “FAILED”), the method proceeds to 16 at which bacteria is transferred from a bacterial backup container having bacteria therein to the bioreactor. If the condition satisfies a second criterion or a first set of criteria (a situation referred to as “PASSED”), the method proceeds to 18 at which bacteria is transferred from the bioreactor to the backup container. In various exemplary embodiments of the invention the backup container is drained 17 prior to the transfer of bacteria into the backup container, and in various exemplary embodiments of the invention the bioreactor is drained 15 prior to the transfer of bacteria into the bioreactor. It is to be understood, however, that although in some embodiments the bioreactor or bacterial backup container are drained prior to the transfer of bacteria thereinto, this need not necessarily be the case, since, for some applications, it may not be necessary for draining the bioreactor or backup container. Specifically, in some embodiments of the present invention the bacteria can be added to the bacteria already present in the bioreactor or backup container. For example, the method can operate in a “semi-continuous” mode in which each time the first set of criteria (“FAILED”) is met, more bacteria are added from the backup container to the bioreactor without draining the bioreactor.

Also contemplated, are modes of operation in which the bacteria are transferred from the bioreactor to the backup container semi-continuously. In these operation modes, each time the second set of criteria (“PASSED”) is met, more bacteria are added from the bioreactor to the backup container without draining the backup container.

In various exemplary embodiments of the invention at least part of the method is executed automatically, for example, using a controller which relieves test data from the sensors and applies the criteria responsively to the test data. The controller can also signal a fluid locomotion system for transferring the bacteria to or from the bioreactor or bacterial backup container, according to decision 14. Optionally, several additional manual operations can be employed. For example, when the condition of the bacteria in the bioreactor and/or backup container requires human intervention, a report or alarm can be generated, to call for an on-site visit of a service team.

As the terms “FAILED” and “PASSED” may imply, the first and second sets of criteria are selected such that meeting the first set of criteria indicates that the capability of the bacteria to adequately treat the waste material was reduced or no longer exists, and meeting the second set of criteria indicates that the bacteria adequately treats the waste material, namely that the biological process can continue, preferably without further intervention.

One example of a FAILED situation is an upset. An upset is defined as any abnormal conditions, anomalies or interruptions in the treatment process or the distribution system that may reduce the quality of treatment and consequently the quality of the treated material at the outlet of the system. An upset can occur, for example, when there are significant variations in the flow of waste material into the bioreactor, or significant variations in the characteristics of the waste material. An upset can also be a result of an over buildup of biomass, or human error in operating the system.

The method can declare a FAILED situation if there is a suspicion to a toxic material in the influent. Such a situation can be detected if there is a combination of set of parameters that indicates existence of such toxic material. For example, when OUR and the treatment efficiency is decreased (e.g., TOC in the outlet versos TOC in the inlet), but temperature or organic load are not decreased the method can declare a FAILED situation.

It is to be understood, however, the above example of OUR based sets of criteria is not intended to be limiting and that many other criteria may be employed, preferably using one or more of the parameters described above. The criteria may be formulated as a single threshold (e.g., when a single parameter is used for monitoring the condition, or when a single score is calculated from a plurality of parameters) or a set of thresholds. The thresholds can indicate parameter levels, variations in parameter levels, or rate of change in parameter levels.

Unlike the bacterial population of the bioreactor, which is contacted with the waste material for performing the biological treatment within the bioreactor, the bacteria of the backup container are preferably kept isolated from the waste material. Since the bacteria are transferred to the backup container only when the condition of the bacteria in the bioreactor is declared as PASSED, the backup container essentially serves, at all times, as a replica of the last adequate state of the bioreactor. It is to be understood, however, that the bacteria in the backup container may also be of a different type than the bacteria in the bioreactor. These embodiments are particularly useful when more than one backup container is employed, as further detailed hereinunder.

Nevertheless, in some embodiments of the present invention, part of the influent waste material is allowed to enter the backup container. This is particularly useful in embodiments in which it is desired to use the waste material as nutrition to the bacteria in the backup container. Preferably, the waste material and its condition are tested before allowing it to enter the backup container, so as to ensure that the waste material is suitable as nutrition. For example, when the waste material is toxic to the bacteria, it is not allowed to enter the backup container.

The criteria at 14 or the criteria applied for allowing waste material from the influent to enter the backup container are preferably selected such that the bacteria in the backup container are maintained at a sufficiently high viability state at all times.

The term “viable bacteria” as used herein refers to a population of bacteria that is capable of replicating under suitable conditions. Preferably, at least 0.1% of the bacteria present in the viable population of bacteria are capable of colony formation using standard bacterial plating methods known to those skilled in the art, preferably at least 60%, more preferably at least 75% and more preferably still at least 90%.

The term “non-viable bacteria” refers to a population of bacteria that is not capable of replicating under known conditions. However, it is to be understood that due to normal biological variations in a population, a small percentage of the population (e.g., 20% or less) may still be viable and thus capable of replication under suitable growing conditions in a population which is otherwise defined as non-viable.

As used herein “sufficiently high viability state” refers to a state of a bacterial population wherein the bacterial activity of the population, as determined directly or via a proxy (e.g., a parameter or set of parameters indicative of the level of bacterial activity) is above a predetermined threshold or can be increased (e.g., by supplementing nutrition to the population) to above the predetermined threshold without increasing the population itself.

For example, bacterial activity can be assessed by measuring the OUR in the backup container. When the OUR is above a predetermined OUR threshold OUR_{MIN} the method can determine that the bacterial activity is sufficiently high. However, the method can determine the bacteria are at a sufficiently high viability state even when the OUR is below OUR_{MIN}, provided the time period or the accumulated time at which the OUR was below OUR_{MIN} is sufficiently short, e.g., at most T_{MAX}, where T_{MAX} is a predetermined time threshold.

Thus, in various exemplary embodiments of the invention the method determines that the bacteria are at a sufficiently high viability state if one of the following conditions is met: (i) the OUR is at least OUR_{MIN}, and (ii) the OUR is below OUR_{MIN} for a time period which is at most T_{MAX}. A typical value for OUR_{MIN} is below 10 mg/(liter*hour), preferably below about 4 mg/(liter*hour), where an asterisk represents the multiplying operator, and a typical value for T_{MAX} is below 240 hours, preferably from about 12 hours to about 150 hours.

In some embodiments of the invention the backup container and the bioreactor are kept at the same environmental conditions, particularly temperature and oxygen level.

When the condition of the bacteria in the bioreactor is declared FAILED and the bacteria are transferred from the backup container to the bioreactor, the last adequate state of the bioreactor is restored from the replica in the backup container. This allows the method of the present embodiments to rapidly restart the treatment system following an upset. An additional advantage of the present embodiment is that the bacterial population in the backup container is already adapted to the conditions at the bioreactor. Thus, the content of the backup container serves as a starter for biomass build up in the bioreactor. This embodiment is advantageous over traditional waste material treatment systems in which the restart of biomass buildup in the bioreactor following an upset is a prolonged process.

In some embodiments of the present invention the method uses information regarding the expected condition in the treatment system so as to determine whether or not to transfer the bacteria from the backup container to the bioreactor. Such information can be transmitted, e.g., by the operator or an automatic scheduling module which has some knowledge of the expected contents of the influent. For example, some waste material treatment facilities employ a wash step in which the system is washed by sodium hydroxide. Prior to such wash step, the method preferably indicates that the bacteria are not to be transferred from the backup container to the bioreactor. Prior to a wash step by sodium hydroxide, the method can divert the waste material to a secondary channel as further detailed hereinunder.

As stated, more than one bacterial backup container can be employed. In this embodiment, two or more backup containers preferably contain different type of bacteria. Thus, in this embodiment, the bacteria in at least one of the backup container are different from the bacteria in the bioreactor. The bacteria in the different backup containers can be engineered or selected for treating preselected and specific abnormal conditions in the bioreactor. For example, in some embodiments the method employs a bacterial backup container having therein bacteria that are capable of degrading phenols, in some embodiments the method employs a bacterial backup container having therein bacteria that are capable of growing at high concentrations of ammonia, in some embodiments the method employs a bacterial backup container having therein bacteria that are capable of growing at high concentrations of heavy metals, in some embodiments the method employs a bacterial backup container having therein bacteria that are capable of growing at high temperature, in some embodiments the method employs a bacterial backup container having therein bacteria that are capable of growing at low temperature, in some embodiments the method employs a bacterial backup container having therein bacteria that are capable of growing in an environment of high salinity, in some embodiments the method employs a bacterial backup container having therein bacteria that are capable of growing in an environment of low salinity, in some embodiments the method employs a bacterial backup container having therein bacteria that are capable of growing in an environment of high pH and in some embodiments the method employs a bacterial backup container having therein bacteria that are capable of growing in an environment of low pH. Other types of bacteria are not excluded from the scope of the present invention.

The method can then select (23, 24) the bacterial backup container(s) employed at 16, 17 and/or 18 based on the monitored condition and the type of bacteria present in the respective container. Specifically, when the method declares a FAILED situation, the method continues to 23 at which the method selects a bacterial backup container having therein bacteria that are capable of treating the abnormal condition in the bioreactor. The method transfers 16 the bacteria from the selected backup container to the bioreactor. The transferred bacteria are either added to the bacteria already present in the bioreactor or replace the bacteria in the bioreactor. In the latter case, the method drains 15 the bioreactor before or after the selection 23.

Suppose, for example, that the method determine at 12 that there is a high level of phenols (e.g., above 1000 mg per liter) in the bioreactor. In this case, the method declares a FAILED situation, proceeds to 23 at which the method selects a bacterial backup container having therein bacteria that are capable of degrading phenols, and continues as further detailed hereinabove.

Typically, the volume of the bacterial backup container is significantly smaller than the volume of the bioreactor. Smaller volume of the backup container is preferred from the standpoint of cost, and larger volume of the backup container is preferred from the standpoint of time consumption. Preferably, the volume of the backup container is less than 20%, or less than 15%, or less than 10%, e.g., 5% of the volume of the bioreactor. Preferably, the volume of the backup container is at least 0.1% of the volume of the bioreactor or at least 10 liters. Other volume ratios are not excluded from the scope of the present invention.

From 16 the method optionally and preferably proceeds to 20 at which the generation of biomass in the bioreactor is enhanced. This can be done, for example, by increasing the flow of nutrition/waste material and air into the bioreactor, or increasing the temperature until sufficient amount of biomass is built.

The method can be repeatedly executed according to a predetermined time-schedule. Specifically, from any of the operations, particularly 16, 18 and 20, the method can loop back (e.g., to 12, 13 or 14). The time-schedule can also be adapted dynamically by the method. For example, following an upset, decision 14 can be executed more rapidly. The method can also apply at 14 an additional set of criteria for determining future time-intervals between two successive executions of operation 12 or decision 14. For example, when the condition of the bacteria as monitored at 12 or wastewater as monitored at 13 indicates that the an upset is approaching, the rate of executions of operation 12 or 13, or decision 14, can be increased, and when the condition of the bacteria indicates that an upset is not likely to occur, the rate of executions of operation 12 or 13, or decision 14, can be decreased.

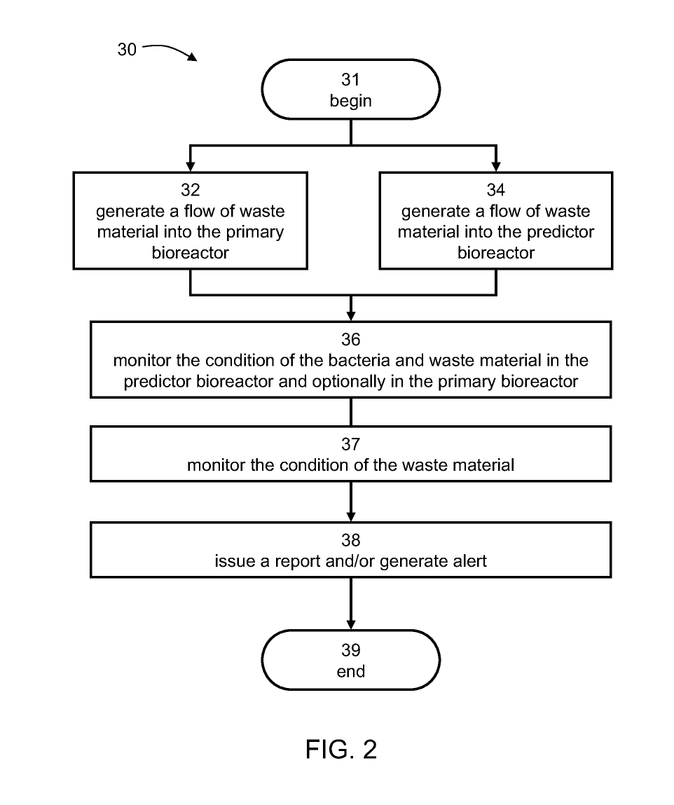

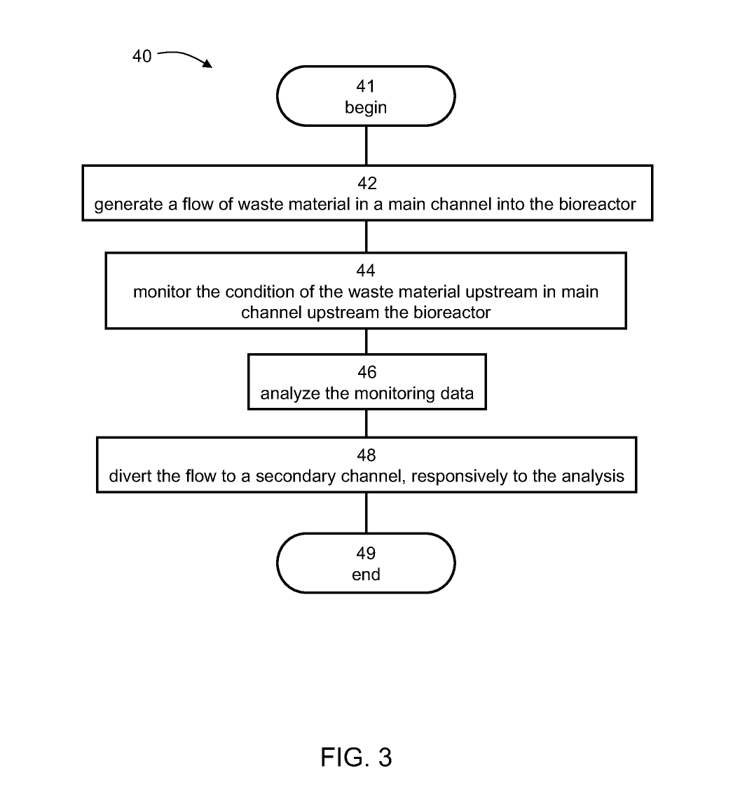

Additionally or alternatively, the method can execute a prediction routine, for predicting the likelihood of process failure events and effluent quality that is outside of desired or required quality parameters. For example, the prediction routine can predict the likelihood of a future upset or sludge bulking. In these embodiments, the time-schedule of method 10 is preferably updated, at least in part, based on prediction data generated by the prediction routine. The prediction data can also be used by method 10 for deciding whether to transfer bacteria from the backup container to the bioreactor or from the bioreactor to the backup container. Representative examples of prediction routines suitable for the present embodiments are provided hereinbelow with reference to FIGS. 2 and 3.

Also contemplated is the use of one or more optimization routines, which may be arranged to determine, e.g., when energy is being wasted. For example, the optimization routine can optimize the amount of oxygen, air or nutrition (nitrogen, phosphorous, etc.) that is being used for maintaining the biological process.

The method ends at 22.

Reference is now made to FIG. 2 which is a flowchart diagram illustrating a method 30 suitable for predicting the condition of bacteria/waste material in a bioreactor of a waste material treatment system, according to various exemplary embodiments of the present invention. The waste material treatment system can be of any type, provided at least part of the treatment is in a bioreactor via a biological process as further detailed hereinabove. Selected operations of method 30 can be executed by method 10, e.g., for determining the likelihood of a future upset and optionally updating the scheduling of method 10. Also contemplated are embodiments in which selected operations of method 10 are executed by method 30, as further detailed hereinbelow.

Generally, a system suitable for method 30 includes a bioreactor, interchangeable referred to below as “primary bioreactor,” and a secondary bioreactor interchangeable referred to below as “predictor bioreactor.” Both bioreactors are arranged to receive influent of the same waste material, for example, using a branched waste material channel or the like. Preferably, the predictor bioreactor is smaller in size than the primary bioreactor. Preferably, the volume of the predictor bioreactor is less than 20%, or less than 15%, or less than 10%, e.g., 5% of the volume of the primary bioreactor. In some embodiments, the volume of the predictor bioreactor is 1% of the volume of the primary bioreactor, or even less. In some embodiments, the volume of the predictor bioreactor is 100 liters or less. Other volume ratios are not excluded from the scope of the present invention.

The predictor bioreactor employed by method 30 is different in its function than the backup container described above. Whereas the backup container is preferably isolated from the waste material, or being fed by pretested waste material as nutrition, the predictor bioreactor is configured to receive waste material in parallel with the primary bioreactor, as will now be explained. Further, whereas the content of the backup container, particularly the bacterial population therein, is, in some embodiments, regularly replaced (e.g., every few days) the predictor bioreactor is preferably fed with waste material from the influent.

The predictor bioreactor can be fed with waste material continuously or intermittently, as desired. Also contemplated is an operation mode in which the predictor bioreactor is fed with waste material according to a predetermined criterion or set of criteria. In such operation mode the feeding can be initiated and terminated manually (e.g., on demand) or automatically by a controller. The criterion or set of set of criteria for initiation feeding of the predictor bioreactor with waste material can include indication that abnormal condition is likely to occur at the primary bioreactor or at the effluent. This includes an upset as defined above.

The predictor bioreactor can also be fed with waste material from the influent in batches. For example, once an hour approximately a third of the predictor bioreactor's volume can be drained and filled with waste material. The remaining two-thirds of the volume contain a bacterial population in a biologically acceptable medium. The bacteria in the predictor bioreactor are preferably of the same type as the bacteria in the primary bioreactor. Alternatively the predictor bioreactor can be fed by a continuous flow of waste material as further explained below.

Method 30 begins at 31 and continues to 32 at which a flow of waste material is generated and directed into the primary bioreactor, e.g., through waste material inlet; and 34 at which a flow of waste material is generated and directed into the predictor bioreactor, e.g., through waste material inlet. Both bioreactors receive the waste material from the same source, but at different relative flow rates: the relative flow into the predictor bioreactor is preferably larger than the relative flow into the primary bioreactor. In addition to the influent of waste material through the respective waste material inlet, each bioreactor has an effluent of treated material, e.g., through a respective treated material outlet. Typically, the flow at the effluent is approximately the same as at the influent.

Flow rate is a measure that indicates the amount of waste material passing into the respective per unit time. The comparison between the flow rates of the primary and predictor bioreactors is preferably done using relative rather than absolute amounts. Specifically, instead of being expressed in units of volume or weight, the amounts of waste material are expressed relative to the volume or capacity of the respective bioreactor. Typically, the relative flow rate is expressed in units of percent per unit time. For example, a flow rate of P percents per hour means that the amount of waste material entering the respective bioreactor during a period of one hour equals P percents of the capacity of the respective bioreactor. In other words, since the bioreactor's flow at the effluent is approximately the same as at the influent, flow rate of P percents per hour means that at each hour, about P percent of the contents of the respective bioreactor are replaced.

In various exemplary embodiments of the invention, for any given time-interval, the relative amount of waste material entering the predictor bioreactor is at least X times the relative amount of waste material entering the primary bioreactor, where X can equal any number from 1 to 20, inclusive. For example, the relative flow rate for the predictor bioreactor can be about 20% per hour (meaning the total volume of the predictor bioreactor is replaced every 5 hours) and the relative flow rate for the primary bioreactor can be about 10% per hour (meaning the total volume of the primary bioreactor is replaced every 10 hours).

It is appreciated that the absolute amount of waste material flowing into the predictor bioreactor does not have to be larger than the absolute amount of waste material flowing into the primary bioreactor. This is because the two bioreactors are not necessarily equal in size and capacity. Consider, for example, an embodiment in which the predictor bioreactor is smaller than the primary bioreactor. When both bioreactors receive the same amount of material per unit time, the relative amount of input waste material is larger for the predictor bioreactor than for the primary bioreactor.

The present inventors found that an increased flow rate into the predictor bioreactor can be used to predict the condition of the bacteria in the primary bioreactor and/or quality of waste material in the primary bioreactor and/or quality of effluent waste material at a future time. This is because a change in the influent of waste material has a more rapid effect on the bacteria and waste material quality due to the higher relative amount of waste material entering the predictor bioreactor at a given time. The present inventors further found that even when the increased flow rate into the predictor bioreactor does not allow the waste material at the outlet of the predictor bioreactor to be of sufficient quality, the predictor bioreactor can still be used for predicting the condition in the primary bioreactor and/or primary effluent at a future time. This is because the method can detect changes in the parameters that are measured at the predictor bioreactor and use these changes for predicting the condition in the primary bioreactor and/or primary effluent at a future time.

This can be formally explained as follows. Suppose that the conditions in the primary bioreactor and/or primary effluent is complied into a set of functions Fᵢ(t) where t is the time i is an index which represents a condition. The present inventors found that the predictor bioreactor can be utilized to assess the derivative dFᵢ(t)/dt. At any given time t₀, Fᵢ(t=t₀) is known by monitoring the conditions in the primary bioreactor and/or other monitoring location upstream or downstream the primary bioreactor, and dFᵢ(t=t₀)/dt is known by monitoring the conditions in the predictor bioreactor or other monitoring location upstream or downstream the predictor bioreactor. Knowing both Fᵢ(t=t₀) and dFᵢ(t=t₀)/dt the method can predict Fᵢ(t=t₁), where t₁>t₀.

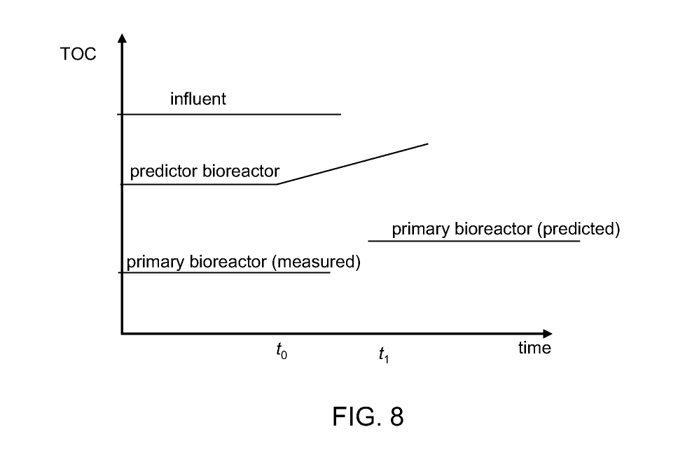

The concept can be better understood with reference to FIG. 8. Suppose for simplicity that the parameter that is monitored is TOC. The method can monitor TOC in the primary bioreactor and in the predictor bioreactor. Suppose further that over a certain period of time the TOC level at both bioreactors as well as in the influent is generally constant, with a higher level in the predictor bioreactor than in the primary bioreactor. At a certain time t₀, the method identifies an increase in the predictor bioreactor but not in the primary bioreactor. The method can then calculate the TOC level in the primary bioreactor in a future time t₁ using the base level that is measured in the primary bioreactor and the slope that characterizes the measured increment in the predictor bioreactor.

The method continues to 36 at which the condition of bacteria/waste material in the predictor bioreactor and optionally in the primary bioreactor is monitored. At 37 the method optionally and preferably also monitors the condition of the waste material at one or more monitoring locations, including, without limitation, at the predictor bioreactor, at the primary bioreactor, upstream the predictor bioreactor, upstream the primary bioreactor, downstream the predictor bioreactor and downstream the primary bioreactor.

Any of the monitoring operations 36 and 37 can independently be done continuously or intermittently, as desired. The condition can be monitored using one or more sensors and/or one or more analyzer(s) arranged to measure one or more parameters. If desired, the sensors and/or analyzer(s) can provide continuous data such as provided by a continuously operating electronic instrument. The condition of the bacteria and waste material can be characterized by the measured parameter(s). Any of the aforementioned parameters can be used for characterizing the condition of the bacteria and waste material.

In some embodiments, the condition of the bacteria is characterized by the measured parameter(s) without further analysis. In some embodiments of the present invention the method analyzes the measured parameter(s) to determine the condition of the bacteria and/or waste material. Any of the aforementioned analysis techniques can be employed, including the calculation of statistical distributions and/or scores, and the use of history data, e.g., by means of an artificial neural network and the use of data obtained from simulations. Optionally the monitoring also includes receiving data from other sources and cross-linking data from different sources, as further detailed hereinabove.

In some embodiments of the present invention the predictor bioreactor is maintained in different environmental conditions so as to allow the bacteria therein to treat the waste material even though the influent flow rate is higher. For example, the predictor bioreactor can be kept at an elevated temperature relative to the primary bioreactor or in more homogenous conditions (e.g., better mixing or circulation)

The method continues to 38 at which a report regarding the expected condition of the bacteria in the primary bioreactor is issued. The report can include the measured parameters or a score calculated from the measured parameters. Since the effects in the predictor bioreactor precede those in the primary bioreactor, the parameters or score of the predictor bioreactor are proxy to the condition of the bacteria and/or waste material in the primary bioreactor at a future time. The report can also include an estimation of the likelihood for an abnormal function such as an upset. For example, when an upset occurs in the predictor bioreactor, the report can include indication that an upset is likely to occur also in the primary bioreactor. History data can also be used (e.g., using a neural network algorithm) for estimating that an upset is approaching. In these embodiments, the report can also include the result of such history based estimation. The method can also issue an alert, for example, when there is an upset in the bacteria of the predictor bioreactor. Optionally, several additional manual operations can be employed. For example, when the expected condition of the bacteria in the primary bioreactor requires human intervention, the report or alert can include a call for an on-site visit of a service team.

As stated, selected operations of method 10 can be executed also by method 30. For example, when method 30 determines that an upset is likely to occur, method 30 can transfer bacteria from the backup container to the primary bioreactor. When method 30 determines that the waste material may have negative effect (e.g., high toxicity), the method can indicate that the bacteria from the backup container may be damaged if transferred to the primary bioreactor. In this case the waste material can be diverted, as further detailed hereinunder.

Method 30 can also utilize other techniques for predicting the expected condition of the bacteria in the primary bioreactor. A representative example of such technique is described hereinbelow with reference to FIG. 3.

The method ends at 39.

Reference is now made to FIG. 3 which is a flowchart diagram illustrating a method 40 suitable for treating waste material in a waste material treatment system, according to various exemplary embodiments of the present invention. The waste material treatment system can be of any type, provided at least part of the treatment is in a bioreactor via a biological process as further detailed hereinabove. Selected operations of method 40 can be executed by method 10, e.g., for determining the likelihood of a future upset and optionally updating the scheduling of method 10. Selected operations of method 40 can also be executed by method 30, for example, for enhancing the prediction accuracy of method 30. Also contemplated are embodiments in which selected operations of method 10 and/or method 30 are executed by method 40.

Generally, a system suitable for method 40 includes having a main channel connected through a waste material inlet to a bioreactor. The bioreactor can also include a treated material outlet, as further detailed hereinabove.

The method begins at 41 and continues to 42 at which a flow of waste material is generated in the main channel in the direction of the bioreactor. The method continues to 44 at which the condition of the waste material is monitored in the main channel at a monitoring location upstream of the waste material inlet of the bioreactor.

As used herein “upstream the waste material inlet” refers to any upstream location, both near the inlet and far from the inlet.

Optionally, the monitoring can be within the bioreactor and/or downstream the treated material outlet of the bioreactor.

The monitoring can be done continuously or intermittently, as desired. The condition can be monitored using one or more sensors or analyzers arranged to measure one or more parameters, wherein the condition of the waste material can be characterized by the respective parameter(s). The condition can also be characterized by a score calculated using the measured parameters. The score can be calculated using a predetermined relation between the score and each of various measured parameters or it can be calculated adaptively, using history data from previous measurements. For example, an artificial neural network algorithm can be employed for calculating the score for any set of parameters based on the measured value of the parameters and on history data. The parameters can include temperature, pH, fluid flow, salinity or the like. When the monitoring is in the bioreactor, the parameters can include any of the parameters described above in connection to method 10 and 30. When the monitoring is upstream the waste material inlet, the parameters can include, without limitation, pH, Temperature, TPH, COD, BOD, TOC, NPOC, TC, TIC, Oil and grease, TSS, Turbidity, bacterial concentration as obtained by any method, Conductivity, Chloride, Salinity, Total Nitrogen, Ammonia, Ammonium, Nitrite, Nitrate, N₂, Total phosphate, PO₄, OOP, Poly-Phosphates, Sulfide, Sulfate, Phenol, PAH, Detergents, VSS, Cyanide and Optical absorbance. Also contemplated is the estimation of DO and OUR based on one or more of the parameters measured upstream the bioreactor.

The monitoring can also include receiving data from sources other than hard process or environmental instrumentation. The data may come from laboratory instruments or from real-time databases of information collected at the facility at which the system is deployed. Further, monitoring can include receiving discrete or non numeric data such as an indication that a sludge pump is operating or sludge level is rising. Still further, monitoring can also include receiving data other than an instrument reading or test result, such as an operator voice record or a plant camera video input.

The method continues to 46 at which the data are analyzed. The analysis can include estimating the condition of the bacteria in the bioreactor and/or waste material at any location (in, upstream and/or downstream the bioreactor). More preferably, the collected data or score can be used for estimating the expected condition of the bacteria and/or waste material at a future time. As a representative example, consider a set of N measured parameters, each having a measured numerical value Vᵢ, i=1, . . . , N. The method can apply a criterion to each Vᵢ (e.g., by comparing it to a respective predetermined threshold Tᵢ), for example, for determining whether or not Vᵢ indicates possible abnormal condition in the system. The method can also assign a weight Wᵢ to Vᵢ, where Wᵢ can be predetermined or it can be calculated after the respective criterion is applied (e.g., based on the difference Vᵢ-Tᵢ). Based on the applied criteria, the method can apply a statistical procedure for calculating the likelihood that an abnormal condition in the system will occur. For example, the method can calculate the ratio between the number of parameters that indicate possible abnormal condition and the total number of parameters. When, weights are assigned, each parameter is weighted by the respective weight.

Other statistical techniques can also be employed. For example, the method can calculate probability distributions for selected parameters. Preferably, the distributions are multidimensional so as to increase the likelihood that important predictions that result form multiple data or factors will be considered for potential future problems. The distributions are especially useful in helping decision makers evaluate how the downstream treatment process will behave and what parameters to expect, if no changes are made in the operation of the facility.

In some embodiments of the present invention the collected data are stored in a database. A computer, supplemented by an artificial neural network algorithm, can access the database and learn the data over time and develop strategies to handle future problems and operation conditions that appear similar to or related to past problems and operational conditions. The neural network algorithm can evaluate the incoming process data, including facility operation data and environmental data, to determine incoming noise, data gaps, data equality, errors and failures of hardware sensors that may have occurred. The neural network algorithm can also use history information, data manipulation, data averaging, data from other sensors or the like. In some embodiments of the present invention the neural network algorithm can employ pattern recognition for searching the incoming data to find matches with previous data and operational modes (or predicted data where no prior data exists) to locate patterns that are recognized as possibly leading to upsets.

The neural network algorithm preferably provides values for missing data and eliminating erroneous data. The neural network algorithm can then use the resulting modified data to predict process upsets and the condition of the treated waste material. The neural network algorithm can also detect potential operational problems and undesirable process situations. The neural network algorithm can optionally provide recommendations with respect to proactive measures that facility operators can take to resolve such potential problems and situations.

In some embodiments of the present invention the method issues a report regarding the results of the analysis. If the analysis of the data indicates that an upset or other abnormal condition is likely to occur at the bioreactor, at least a portion of the waste material flow is optionally diverted 48 to a secondary channel, so as to prevent the upset from occurring. In some embodiments of the present invention the waste material is diverted to a secondary channel when the method receives direct information that the expected influent waste material can damage the bacteria. For example, prior to a wash step by sodium hydroxide, the method diverts the waste material to a secondary channel.

The secondary channel can direct the diverted waste material to a storage facility or a special treatment zone. Optionally, once the problem is resolved, the stored waste material can be redirected back to the bioreactor for treatment. This can be done at a different, e.g., reduced flow rate.

As an example, consider a situation in which the method identifies high sulfide contamination. In this case, the waste material is preferably diverted to a chemical treatment zone in which the sulfide is oxidized. This is advantageous since the sulfide can be oxidized relatively rapidly via a chemical process while preventing competition between the chemical process and the biological process. Otherwise the sulfide is a burden on the aeration system in the reactor since it scavenges the dissolved oxygen. The oxidation can be in the presence of air, oxygen, oxygen enriched air, or any other oxygen agent such as, but not limited to, hydrogen peroxide. Following oxidation, the waste material can be directed back into the bioreactor.

As another example, consider a situation in which the method identifies presence of hardly degraded or toxic compounds. In this case, the waste material is preferably diverted to a treatment zone in which an advanced oxidation process (AOP) is employed. In this process, an oxidizer, such as ozone, fluorine, hydrogen peroxide, potassium permanganate, hypobromous acid, hypochlorous acid, chlorine, or mixtures thereof, is forced through the waste material, preferably in high concentrations. Additionally, an ultraviolet (UV) radiation can be used. For example, when the hydrogen peroxide absorbs UV radiation, it breaks up into highly-reactive hydroxyl radicals that react with and oxidize organic chemical compounds present in the waste material. As an optional enhancement, an electrical variable or pulsed current from a non-sacrificial anode (not shown) is driven through the waste material. The current causes the formation of hydroxide ions which in combination with the oxidizer interacts with the water, reducing remaining impurities. AOPs suitable for the present embodiments are found in, e.g., U.S. Pat. Nos. 6,461,522, 6,090,296 and 5,178,755, the contents of which are hereby incorporated by reference. Following this treatment, the waste material can be directed back into the bioreactor.

As stated, selected operations of method 10 and/or method 30 can be executed by method 40. For example, when method 40 determines that an upset is likely to occur, method 40 can transfer bacteria from the backup container to the primary bioreactor. Another example is an embodiment in which the predictor bioreactor is employed wherein the analysis 46 also includes analysis of test data pertaining to the condition of the bacteria in the predictor bioreactor.

The method ends at 49.

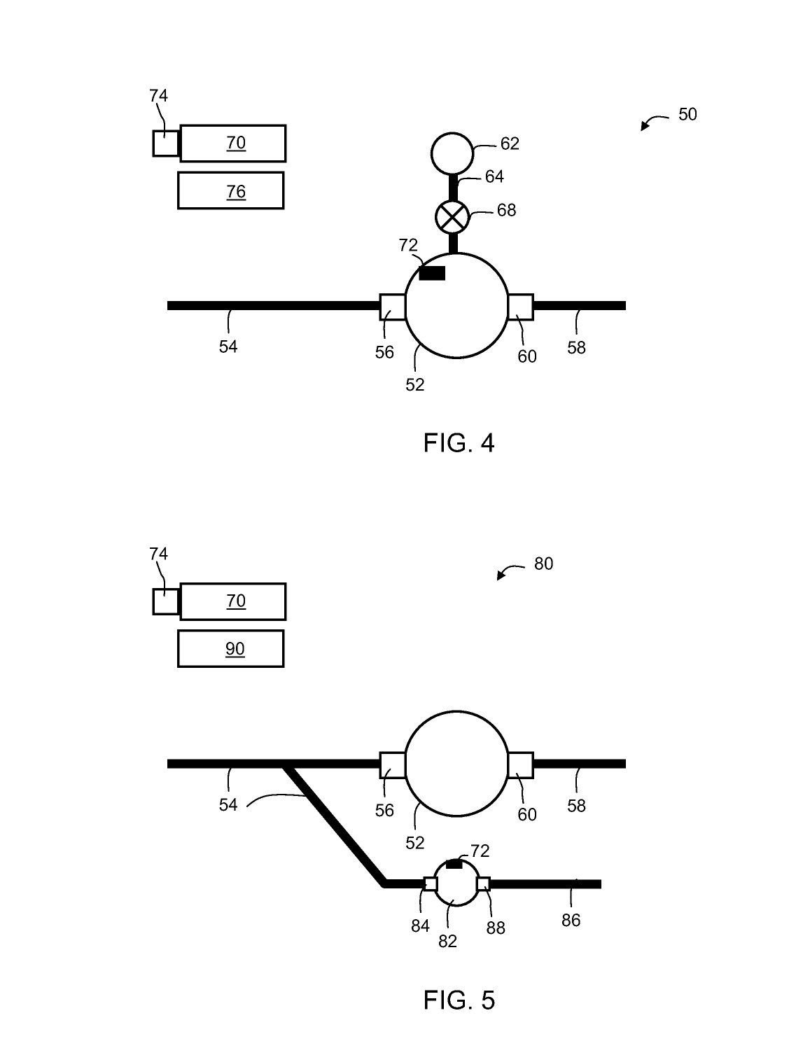

Reference is now made to FIG. 4 which is a schematic illustration of a top view of a waste material treatment system 50, according to various exemplary embodiments of the present invention. System 50 can be used for executing selected operations of method 10. System 50 comprises a bioreactor 52 having therein bacteria, e.g., organisms, microorganisms, bacteria and the like. The waste material is treated in bioreactor 52 via a biological process featured by the bacteria. In some embodiments system 50 is configured to operate as an automated chemostat system, in some embodiments system 50 is configured to operate as an activated sludge system, in some embodiments system 50 is configured to operate as a membrane bioreactor system, and in some embodiments system 50 is configured to operate as a sequencing batch reactor (SBR). Other types of configurations are not excluded from the scope of the present invention.

Bioreactor 52 receives a flow of waste material, such as, but not limited to, wastewater, from a source of waste material (not shown), via a main influent channel 54 which is connected bioreactor 52, optionally by means of a waste material inlet 56. Bioreactor 52 treats the waste material and produces an effluent of treated material which is conveyed away from bioreactor by means of an effluent channel 58 which is connected to bioreactor 52, optionally via a treated material outlet 60. The treated material can be released to the environment or conveyed to an additional treatment zone (not shown). The additional treatment zone can include, for example, a bioreactor similar to bioreactor 52 with the same or different bacteria. The additional treatment zone can also include a system similar to system 50.

In various exemplary embodiments of the invention system 50 comprises a bacterial backup container 62. Although system 50 is shown as having a single backup container, this need not necessarily be the case, since in some embodiments more than one backup container is employed.

Backup container 62 also contains bacteria, as further detailed hereinabove. In embodiments in which more than one backup container is employed, each such container can include a different type or types of bacteria, as further detailed hereinabove. Unlike bioreactor 52, backup container 62 is isolated from the waste material in channel 54. On the other hand, there is a temporal fluid communication between backup container 62 and bioreactor 52. In FIG. 4, the fluid communication is illustrated as a channel 64, interconnecting backup container 62 and bioreactor 52, and a valve and/or pump 68 mounted on channel 64. Pump 68 serves for establishing a one way flow within channel 64 either from backup container 62 to bioreactor 52 or from bioreactor 52 to backup container 62. Other types of fluid communications (e.g., two or more channels) are also contemplated.

System 50 preferably comprises a monitoring unit 70 which monitors the condition of the bacteria in bioreactor 52 and optionally backup container 62. Unit 70 can receive data from a sensor or sensors 72 arranged to measure one or more parameters. Although sensors 72 are shown positioned in bioreactor 52 this need not necessarily be the case, since sensors 72 can be located also in other locations, including without limitation, channel 54, channel 58 and backup container 62. In some embodiments of the present invention at least one sensor is positioned in bioreactor 52. Monitoring unit 70 can also receive data from other sources, as further detailed hereinabove. The data can be transmitted from sensors 72 or any other source to monitoring unit 70 by wired or wireless communication channels (not shown).

Monitoring unit 70 can monitor the data continuously or intermittently, as desired. If desired, sensors 72 can provide continuous data such as provided by a continuously operating electronic instrument. The condition of the bacteria can be characterized by the measured parameter(s). Any of the aforementioned parameters can be used for characterizing the condition of the bacteria in bioreactor 52 and optionally backup container 62. Monitoring unit 70 can use the measured parameter(s) for characterizing the condition of the bacteria and/or waste material with or without further analysis. In embodiments in which further analysis is employed, the analysis can be performed using a data processor 74 which may be embodied as part of unit 70 or as a separate unit. Any of the aforementioned analysis techniques can be employed by unit 70 or processor 74, including the calculation of statistical distributions and/or scores, and the use of history data, e.g., by means of an artificial neural network.

System 50 also comprises a controller 76 which receives from monitoring unit 70 test data pertaining to the condition of the bacteria/waste material in bioreactor 52 and optionally backup container 62. Responsively to the data, controller 76 transfers bacteria between bioreactor 52 and backup container 62. Controller 76 can ensure the transfer of bacteria, for example, by controlling the operation of pump 68. If the condition of the bacteria satisfies the aforementioned first set of criteria (“FAILED”), controller 76 signals pump 68 to transfer the bacteria from backup container 62 to bioreactor 52, and if the condition satisfies the aforementioned second set of criteria (“PASSED”), controller 76 signals pump 68 to transfer the bacteria from bioreactor 52 to backup container 62, as further detailed hereinabove.

In various exemplary embodiments of the invention controller 76 is also configured to drain bioreactor 52 prior to the transfer of bacteria from backup container 62 to bioreactor 52, and to drain backup container 62 prior to the transfer of bacteria from bioreactor 52 to backup container 62, as further detailed hereinabove.

Reference is now made to FIG. 5 which is a schematic illustration of a top view of a waste material treatment system 80, according to various exemplary embodiments of the present invention. System 80 can be used to execute selected operations of method 30. System 80 comprises bioreactor 52 and can be configured to operate according to any configuration (chemostat, activated sludge system, membrane bioreactor, SBR etc.) as further detailed hereinabove. Bioreactor 52 is interchangeably referred to below as primary bioreactor 52.

System 80 preferably comprises a predictor bioreactor 82 which also contains bacteria. Typically, predictor bioreactor 82 is smaller than primary bioreactor 52. As shown in FIG. 5, main influent channel 54 is a branched channel such that both bioreactors 52 and 82 receive the waste material (e.g., wastewater) from the same source (not shown). Similarly to primary bioreactor 52, predictor bioreactor 82 can receive the waste material through a waste material inlet, shown at 84, and produce an effluent of treated material into another effluent channel 86 which can be connected to predictor bioreactor 82 by a treated material outlet 88.

The relative flow into predictor bioreactor 82 is preferably larger than the relative flow into primary bioreactor 52, as further detailed hereinabove. In various exemplary embodiments of the invention, for any given time-interval, the relative amount of waste material entering the predictor bioreactor is at least X times the relative amount of waste material entering the primary bioreactor, where X can have any of the aforementioned values.

System 80 comprises monitoring unit 70 which monitors the condition of bacteria in predictor bioreactor 82. Unit 70 of system 80 can receive data from a sensor or sensors 72 arranged to measure one or more parameters. Although sensors 72 are shown positioned in predictor bioreactor 82 this need not necessarily be the case, since sensors 72 can be located also in other locations, include, without limitation, channel 54 (both branches or upstream), channel 58, channel 86, and primary bioreactor 52. In some embodiments of the present invention at least one sensor is positioned in predictor bioreactor 82. Monitoring unit 70 can also receive data from other sources, as further detailed hereinabove. The data can be transmitted from sensors 72 or any other source to monitoring unit 70 by wired or wireless communication channels (not shown). The principles and operations of monitoring unit 70 when embodied in system 80 are generally the same as the principles and operations of monitoring unit 70 when embodied in system 50.

System 80 preferably comprises a controller 90 which receives from monitoring unit 70 test data pertaining to the condition of the bacteria/waste material in predictor bioreactor 82, and, responsively to the test data, issues a report regarding the expected condition of the bacteria in primary bioreactor 52, as further detailed hereinabove.

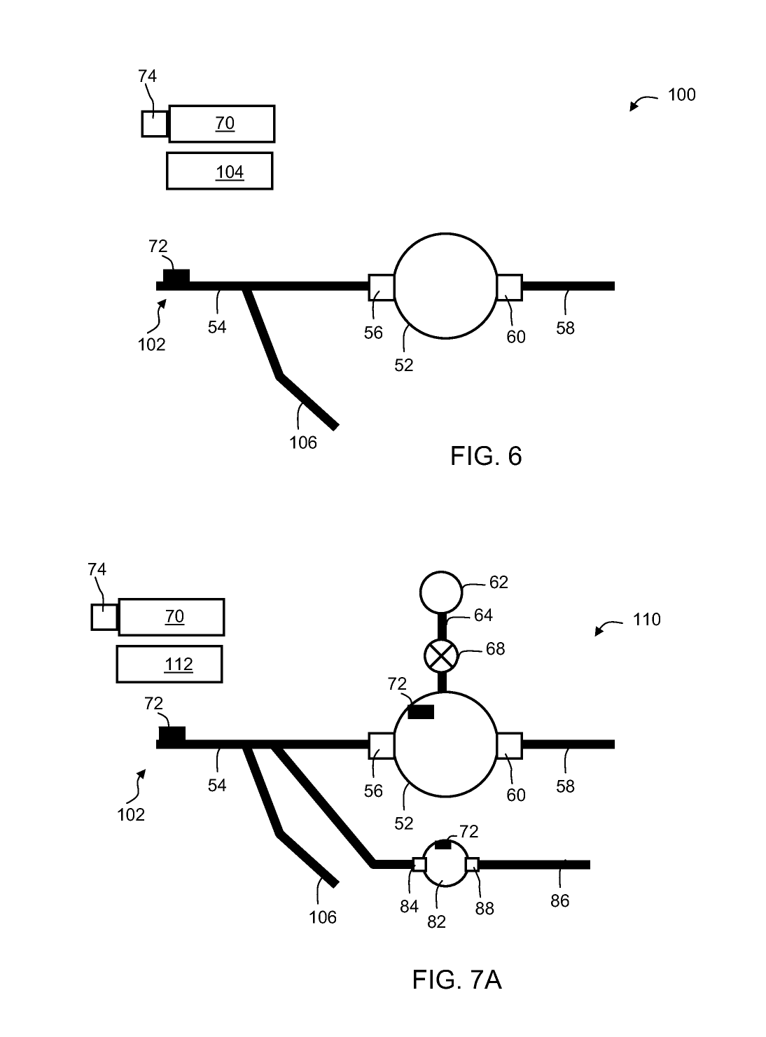

Reference is now made to FIG. 6 which is a schematic illustration of a top view of a waste material treatment system 100, according to various exemplary embodiments of the present invention. System 100 can be used to execute selected operations of method 40. System 100 comprises bioreactor 52 and can be configured to operate according to any configuration (chemostat, activated sludge system, membrane bioreactor, SBR etc.) as further detailed hereinabove.

System 100 comprises monitoring unit 70 which monitors the condition of the waste material in main influent channel 54 at a monitoring location 102 upstream waste material inlet 56 of bioreactor 52, as further detailed hereinabove. System 100 further comprises a controller 104 configured for receiving from monitoring unit 70 test data pertaining to the condition of the waste material, analyzing the test data, and diverting at least a portion of flow to a secondary channel 106, responsively to the analysis as further detailed hereinabove.

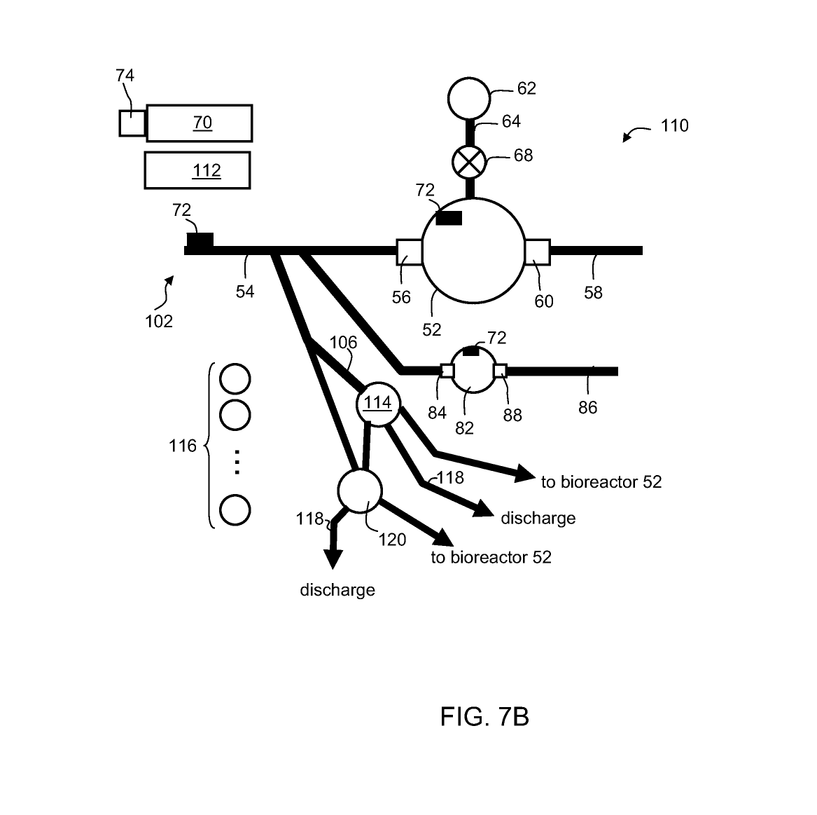

Reference is now made to FIGS. 7A and 7B which are schematic illustrations of a top view of another waste material treatment system 110, according to various exemplary embodiments of the present invention. System 100 can be used to execute selected operations of methods 10, 30 and 40. System 110 comprises bioreactor 52 and can be configured to operate according to any configuration (chemostat, activated sludge system, membrane bioreactor, SBR etc.) as further detailed hereinabove. System 110 further comprises monitoring unit 70 a controller 112 and at least one of backup container 62 and predictor bioreactor 82. Monitoring unit 70 can monitor the condition of the bacteria in bioreactor 52 and/or the condition of the bacteria in predictor bioreactor 82 and/or the condition of the waste material in at location 102 upstream inlet 56. Monitoring unit 70 can also monitor the condition of the bacteria and/or waste material in backup container 62. Monitoring unit 70 can also receive data from other locations and sources as further detailed hereinabove. Monitoring unit 70 can analyze the data, e.g., by means of data processor 74 and transmit the analysis to controller 112. Controller 112 can also analyze the data. Based on the analysis, controller 112 can perform various controlling operations and issues various reports, as further detailed hereinabove with respect to methods 10, 30 and 40, and with respect to systems 50, 80 and 100.

With reference to FIG. 7B, system 110 may optionally comprise a side bioreactor 114 which is fed by waste material via a secondary channel (e.g., channel 106). Although system 110 is shown as having a single side bioreactor, this need not necessarily be the case, since in some embodiments, more than one side bioreactor is employed.

Side bioreactor 114 can be fed regularly (either continuously or intermittently) or, more preferably, only when the analysis of the data indicates that an upset or other abnormal condition is likely to occur bioreactor 52. Side bioreactor 114 can serve as a special treatment zone which allows handling waste material identified as being abnormal or at an abnormal condition. Side bioreactor 114 can facilitate biological treatments. The retention time is preferably, but not necessarily, longer in side bioreactor 114 than in bioreactor 52, since the waste material entering side bioreactor 114 than is typically abnormal or at an abnormal condition.

In some embodiments of the present invention side bioreactor 114 is designed and constituted to treat waste material having high temperature and/or high salinity and/or high pH and/or high content of ammonia or amines and/or high content of heavy metals and/or high phenol content. This can be done, for example, by introducing into side bioreactor 114 bacteria that are engineered or selected for treating such conditions. The skilled person would know how to engineer or select bacteria that are capable of degrading phenols, bind heavy metals and/or are capable of growing at such conditions. Side bioreactor 114 can also be designed and constituted for nitrifying the waste material. This is useful, for example, when the level of ammonia in the waste material is high.

The biological treatment featured by bioreactor 114 can be realized in more than one way. In some embodiments, system 110 comprises several types of side reactors each featuring a different type of biological treatment (e.g., having bacteria that are engineered or selected to treat a different type of abnormal condition). In some embodiments, bioreactor 114 is in fluid communication with a set 116 of bacterial backup containers, each having bacteria that are engineered or selected to treat a different type of abnormal condition. responsively to the condition in the bioreactor is abnormal, controller 112 transfers the bacteria from the respective backup container to bioreactor 114 as further detailed hereinabove with respect to method 10. For clarity of presentation, the fluid communication between bacterial backup containers 116 and bioreactor 114 is not shown in FIG. 7B. The skilled person would know how to establish such communication, e.g., by means of an arrangement of channels or conduits independently connecting each of containers 116 with bioreactor 114. One or more of containers 116 can also be arranged for transferring bacteria to and from bioreactor 52, as described above with respect to backup container 62.

In some embodiments of the present invention system 110 may optionally comprise a treatment zone 120 designed and constituted for non-biological treatment. Thus, waste material can be directed to zone 120 from any location, including, without limitation, upstream inlet 56, side bioreactor 114, bioreactor 52. For clarity of presentation, connection between zone 120 and bioreactor 52 is not shown. Also contemplated are embodiment in which zone 120 feeds side bioreactor 114 Representative examples of non-biological treatment techniques suitable for the present embodiments include, without limitation, activated carbon treatment, oxidation, filtration, ultrasound cavitation, dynamic cavitation and the like.

Activated carbon treatment can be realized for example, by adding carbon powder to zone 120, using crystallized carbon column and the like. Activated carbon treatments suitable for the present embodiments are found in, e.g., U.S. Pat. Nos. 3,244,621, 3,455,820, 3,658,697 and 4,076,615, the contents of which are hereby incorporated by reference. In embodiments in which oxidation is employed, zone 120 preferably features the advanced oxidation process (AOP), as further detailed hereinabove. Ultrasound and dynamic cavitation treatments suitable for the present embodiments are found in, e.g., U.S. Pat. Nos. 5,466,367, 5,494,585.

The term “membrane” as used herein refers to a member which facilitates a separation process where the driving force is constituted of a difference in chemical potential over the member.

The chemical potential may be achieved in different ways in different processes. Representative examples include, without limitation, applied pressure, difference in concentration or temperature and a difference in electric potential.

Membranes suitable for the present embodiments include, but are not limited to, ultrafiltration (UF) membranea, hyperfiltration membranes [also known as reverse osmosis (RO) membranes], nanofiltration membranes and microfiltration membranes. Filtration treatments suitable for the present embodiments are found in e.g. U.S. Pat. No. 6,054,050

Following the treatment within reactor 114 and/or zone 120, the waste material can be discharged, e.g., via one or more discharge channel 118. This embodiment is particularly useful when the effluent from reactor 114 and/or zone 120 is sufficiently clean. Alternatively, the waste material can be transferred from reactor 114 and/or zone 120 back to bioreactor 52 for further treatment. This embodiment is particularly useful when the conditions of the waste material following the treatment within reactor 114 and/or zone 120 are suitable for treatment in bioreactor 52.

It is expected that during the life of a patent maturing from this application many relevant waste material treatment systems will be developed and the scope of the term waste material treatment systems is intended to include all such new technologies a priori.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of maintaining a bioreactor of a waste material treatment system, the bioreactor having therein bacteria for treating the waste material, the method comprising:
monitoring the condition of the bacteria in the bioreactor;
if said condition satisfies a first set of criteria, then transferring bacteria from a bacterial backup container having bacteria therein to the bioreactor; and
if said condition satisfies a second set of criteria, then transferring bacteria from the bioreactor to said bacterial backup container.

2. The method of claim 1, further comprising monitoring the condition of the waste material, wherein said first and said second set of criteria are applied to said waste material condition.

3. The method according to claim 2, wherein said waste material condition is monitored at one of said bioreactor and downstream said bioreactor.

4. The method according to claim 2, wherein said waste material condition is monitored upstream said bioreactor.

5. (canceled)

6. The method according to claim 2, wherein said waste material condition is characterized by at least one parameter selected from the group consisting of Dissolved oxygen (DO), Oxygen uptake rate (OUR), pH, Temperature, Total petroleum hydrocarbons (TPH), Chemical oxygen demand (COD), Biochemical oxygen demand (BOD), Total organic carbon (TOC), Non-purgable organic carbon (NPOC), Total suspended solids (TSS), Turbidity, Conductivity, Chloride, Salinity, Total Nitrogen, Ammonia, Ammonium, Nitrite, Nitrate, N₂, Total phosphate, PO₄ (Orthophosphate), Oxidised & Ortho Phosphorus (OOP), Poly-Phosphates, Sulfide, Sulfate, Phenol, Poly aromatic hydrocarbons (PAH), Cresol, Detergents, volatile suspended solids (VSS), CO₂, Cyanide, Total carbon (TC), Total inorganic carbon (TIC), Oil and grease, Optical absorbance, and Gas chromatography mass spectrometry parameters.

7. The method according to claim 1, further comprising monitoring the condition of the bacteria in the bacterial backup container.

8. The method according to claim 1, wherein said monitoring the condition of the bacteria and said bacteria transfer is performed automatically.

9. The method according to claim 1, wherein if said condition satisfies said first set of criteria, then the bioreactor is drained prior to said transfer of bacteria from the bacterial backup container to the bioreactor.

10. The method according to claim 7, wherein said bioreactor is fed continuously or intermittently from said bacterial backup container when the condition of the bacteria in said bacterial backup container satisfies a predetermined set of criteria.

11. The method according to claim 1, further comprising, responsively to said condition, selecting a bacterial backup container from a plurality of bacterial backup containers, each having a different collection of bacteria therein.

12. The method according to claim 1, wherein the bioreactor comprises waste material inlet for receiving a flow waste material from a main channel being connected to said waste material inlet, and wherein the method comprises:
monitoring the condition of the waste material in said main channel at a monitoring location upstream of said waste material inlet, to provide test data pertaining to said condition;
analyzing said test data; and
responsively to said analysis, diverting at least a portion of said flow to a secondary channel.

13. The method according to claim 1, comprising:
generating a flow of waste material into the bioreactor, and into a predictor bioreactor, wherein a relative influent flow rate is larger for said predictor bioreactor than for said bioreactor;
monitoring the condition of bacteria and/or waste material in the predictor bioreactor; and
responsively to said condition, issuing a report regarding the expected condition of bacteria in the bioreactor and/or waste material.

14. The method according to claim 1, wherein said bacteria in said bacterial backup container is maintained at a sufficiently high viability state at all times.

15. The method according to claim 1, wherein said first set of criteria corresponds to an upset of the bacteria in said bioreactor.

16. The method according claim 1, wherein the waste material treatment system is one of an activated sludge treatment system, a sequential batch reactor treatment system and a membrane bioreactor treatment system.

17. The method according to claim 1, wherein the waste material treatment system is an automated chemostat treatment system.

18. (canceled)

19. (canceled)

20. A waste material treatment system, comprising:
a bioreactor and a bacterial backup container each having therein bacteria for treating the waste material;
a monitoring unit for monitoring the condition of the bacteria in said bioreactor; and
a controller configured for receiving from said monitoring unit test data pertaining to said condition, and transferring bacteria between said bioreactor and said bacterial backup container responsively to said data;
wherein if said condition satisfies a first set of criteria, then bacteria is transferred from the bacterial backup container to the bioreactor, and if said condition satisfies a second set of criteria, then bacteria is transferred from the bioreactor to the bacterial backup container.

21. The system of claim 20, wherein said monitoring unit is configured for monitoring the condition of the waste material, wherein said first and said second set of criteria are applied to said waste material condition.

22. The system according to claim 20, wherein said monitoring unit is configured for monitoring the condition of the bacteria in said bacterial backup container.

23. The system according to claim 20, wherein said monitoring unit is configured for monitoring the condition of the waste material and wherein said controller is configured for receiving from said monitoring unit test data pertaining to said condition of the waste material and diverting at least a portion of said waste material to a secondary channel responsively to said data.

24. The system according to claim 20, comprising:
a predictor bioreactor having therein bacteria; and
at least one channel for carrying a flow of waste material into said bioreactor and into said predictor bioreactor;
wherein a relative influent flow rate is larger for said predictor bioreactor than for said bioreactor; and
wherein said monitoring unit is configured for monitoring the condition of bacteria and/or waste material in the predictor bioreactor, and wherein said controller is configured for receiving from said monitoring unit test data pertaining to said condition, and issuing a report regarding the expected condition of bacteria and/or waste material in the bioreactor, responsively to said test data.

25. The system according to claim 20, comprising a plurality of bacterial backup containers, each having a different collection of bacteria therein, wherein said controller is configured to select a bacterial backup container from said plurality of bacterial backup containers responsively to said condition.

26. The system according to claim 20, wherein said controller is configured for allowing said bioreactor to continuously or intermittently receive bacteria from said bacterial backup container when the condition of said bacteria satisfies a predetermined set of criteria.

27. The system according to claim 20, wherein said bacteria in said bacterial backup container is maintained at a sufficiently high viability state at all times.

28. The system according to claim 20, wherein said first set of criteria corresponds to an upset of the bacteria in said bioreactor.

29. The system according to claim 20, wherein said monitoring unit is configured for measuring a plurality of parameters and using said parameters for calculating a score.

30. The system according to claim 20, wherein the waste material treatment system is one of an activated sludge treatment system, a sequential batch reactor treatment system and a membrane bioreactor treatment system.

31. The system according to claim 20, wherein the waste material treatment system is an automated chemostat treatment system.

32. (canceled)

33. (canceled)

34. A method of predicting condition of waste material in waste material treatment system, the method comprising:
generating a flow of waste material into a bioreactor and into a predictor bioreactor, wherein a relative influent flow rate is larger for said predictor bioreactor than for said bioreactor;
monitoring the condition of bacteria in the predictor bioreactor; and
responsively to said condition, issuing a report regarding the expected condition of waste material.

35. The method of claim 34, further comprising monitoring the condition of the waste material, wherein said report is issued based on said waste material condition.

36. The method of claim 34, further comprising issuing alert if said condition of the bacteria indicates upset in the bacteria.

37. The method according to claim 36, wherein said predictor bioreactor is kept at a temperature which is different than a temperature of the bioreactor.

38. The method according to claim 37, wherein said waste material condition is monitored at said predictor bioreactor.

39. The method according to claim 38, wherein said predictor bioreactor is kept at a condition selected to accelerate biological processes therein.

40. The method according to claim 34, wherein said monitoring of said condition is done continuously or intermittently.

41. (canceled)

42. The method according to claim 34, further comprising monitoring a first condition of at least one of said bacteria and said waste material in said bioreactor, wherein said monitoring of said condition of said bacteria in said predictor bioreactor is done responsively to said monitoring of said first condition.

43. The method according to claim 34, wherein the waste material treatment system is one of an activated sludge treatment system, a sequential batch reactor treatment system and a membrane bioreactor treatment system.

44. The method according to claim 34, wherein the waste material treatment system is an automated chemostat treatment system.

45. (canceled)

46. (canceled)

47. A waste material treatment system, comprising:
a bioreactor and a predictor bioreactor each having therein bacteria;
at least one channel for carrying a flow of waste material into said bioreactor and into said predictor bioreactor, wherein a relative influent flow rate is larger for said predictor bioreactor than for said bioreactor;
a monitoring unit for monitoring the condition of bacteria in the predictor bioreactor; and
a controller configured for receiving from said monitoring unit test data pertaining to said condition, and issuing a report regarding the expected condition of the waste material, responsively to said test data.

48. The system of claim 47, wherein said monitoring unit is configured for monitoring the condition of the waste material, wherein said report is issued based on said waste material condition.

49. The system according to claim 48, wherein said waste material condition is monitored at said predictor bioreactor.

50. The system according to claim 48, wherein said waste material condition is monitored at one of said bioreactor and downstream said bioreactor.

51. The system according to claim 48, wherein said waste material condition is monitored upstream said bioreactor.

52. (canceled)

53. The system according to claim 47, wherein said monitoring unit is configured for measuring a plurality of parameters and using said parameters for calculating a score.

54. The system according to claim 47, wherein the waste material treatment system is one of an activated sludge treatment system, a sequential batch reactor treatment system and a membrane bioreactor treatment system.

55. The system according to claim 47, wherein the waste material treatment system is an automated chemostat treatment system.

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)
